(19) United States
(12) Patent Application Publication
(10) Pub. No.: US 2010/0274386 A1
(43) Pub. Date: Oct. 28, 2010

(54) METHOD FOR ROTATING A MECHANICAL ARM

(75) Inventors: Chih-Kuang CHANG, Tu-Cheng (TW); Xin-Yuan WU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/641,566

(22) Filed: Dec. 18, 2009

(30) Foreign Application Priority Data
Apr. 25, 2009 (CN) 200910301842.X

(51) Int. Cl. G06F 19/00

(52) U.S. Cl. 700/245

(57) ABSTRACT

A method for rotating a mechanical arm receives origin position parameters and final position parameters of the mechanical arm. A computer determines a position that an end joint of each of sections arrives after each iteration according to the origin position parameters and the final position parameters. The computer calculates a distance between the current position and the final position of the end joint of each of the sections and obtains a minimum distance. The coordinates of the end joint of each of the sections corresponding to the minimum distance is calculated. The computer drives each of the end joints to rotate to the calculated end joint coordinates corresponding to the minimum distance.

### BACKGROUND

1. Technical Field

Embodiments of the present disclosure relate to controlling mechanical arms, and more particularly to a method for rotating a mechanical arm.

2. Description of Related Art

In industry, movement control of mechanical arms is very important. However, it is not easy to control the mechanical arm to rotate to a preset final position accurately and speedily. At present, a plurality of equations need to be enumerated to analyze in order to control the mechanical arm. If the mechanical arm includes a plurality of sections, the method of enumeration to analyze is very complex and the result may not be optimal.

What is needed, therefore, is an improved method for rotating a mechanical arm.

### BRIEF DESCRIPTION OF THE DRAWINGS

FIG. 1 is a block diagram of one embodiment of a system for rotating a mechanical arm.

FIG. 2 is a block diagram of one embodiment of the mechanical arm of FIG. 1.

FIG. 3 is a flowchart of one embodiment of a method for rotating a mechanical arm.

FIG. 4 is a detailed flowchart of one embodiment of block S31 and block S32 in FIG. 3.

### DETAILED DESCRIPTION

All of the processes described below may be embodied in, and fully automated via, functional modules executed by one or more general purpose processors. The functional modules may be stored in any type of computer-readable medium or other computer storage device. Some or all of the methods may alternatively be embodied in specialized computer hardware or communication apparatus.

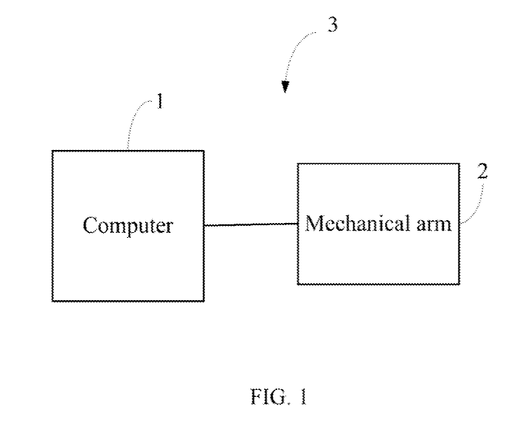

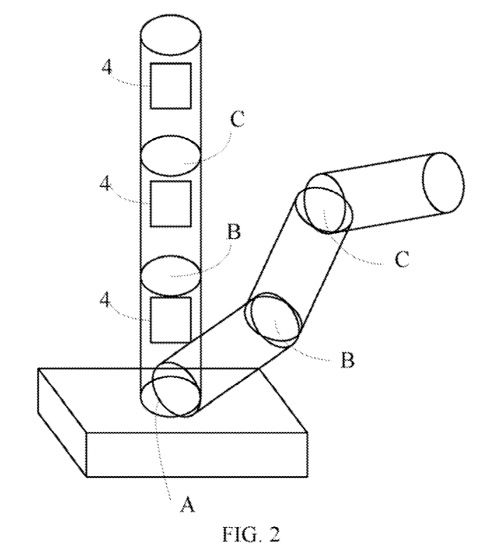

FIG. 1 is a block diagram of one embodiment of a system 3 for rotating a mechanical arm 2. The system 3 includes a computer 1 that is electronically connected to the mechanical arm 2. The mechanical arm 2 may include one or more sections. In one embodiment, as shown in FIG. 2, the mechanical arm 2 includes three sections. Each of the sections includes a base joint and an end joint. A is the base joint of the first section of the mechanical arm. B is the end joint of the first section and the base joint of the second section. C is the end joint of the third section. Each of the end joints is installed with a motor 4. If the computer 1 sends a command to the motor 4, the motor 4 controls the end joint corresponding to the motor 4 to rotate.

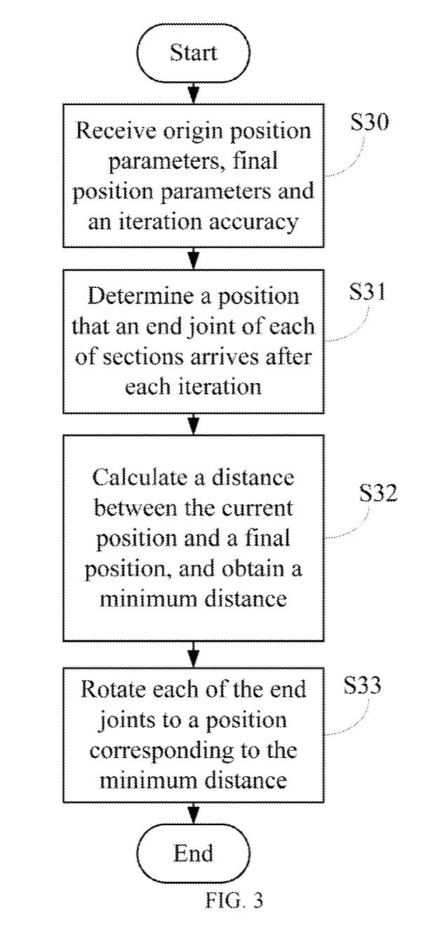

FIG. 3 is a flowchart of one embodiment of a method for rotating the mechanical arm 2 of FIG. 1. Depending on the embodiment, additional blocks may be added, others removed, and the ordering of the blocks may be changed.

In block S30, the computer 1 receives user input. The user input includes origin position parameters of the mechanical arm 2, final position parameters of the mechanical arm 2, and an iteration accuracy FunX. The origin position parameters include origin coordinates of each of the base joints and each of the end joints of each of the sections of the mechanical arm 2 when the mechanical arm 2 is at an origin position. The final position parameters include final coordinates of each of the base joints and each of the end joints of each of the sections when the mechanical arm 2 is at a final position. In one embodiment, the origin coordinate of the base joint A of the first section may be (X_{A}, Y_{A}, Z_{A}). The origin coordinate of the end joint B of the first section may be (X1_{B}, Y1_{B}, Z1_{B}). The final coordinate of the end joint B may be (X2_{B}, Y2_{B}, Z2_{B}). It may be understood that the iteration accuracy FunX is a degree to be reached when each of the sections of the mechanical arm 2 rotates to the final position. Depending on the embodiment, the user input may comprise one or more inputted commands via a hard or software keyboard, or any number of other input devices.

In block S31, the computer 1 determines a position that each of the end joints of each of the sections of the mechanical arm 2 arrives at after each iteration according to the origin position parameters and the final position parameters.

In block S32, the computer 1 calculates a distance between the current position and the final position of the end joint of each of the sections after each iteration. The computer 1 also obtains a minimum distance and calculates coordinates of each of the end joints of each of the sections of the mechanical arm 2 corresponding to the minimum distance.

In block S33, the motor 4 of each of the sections of the mechanical arm 2 drives each of the end joints to rotate to the calculated coordinates of each of the end joints corresponding to the minimum distance.

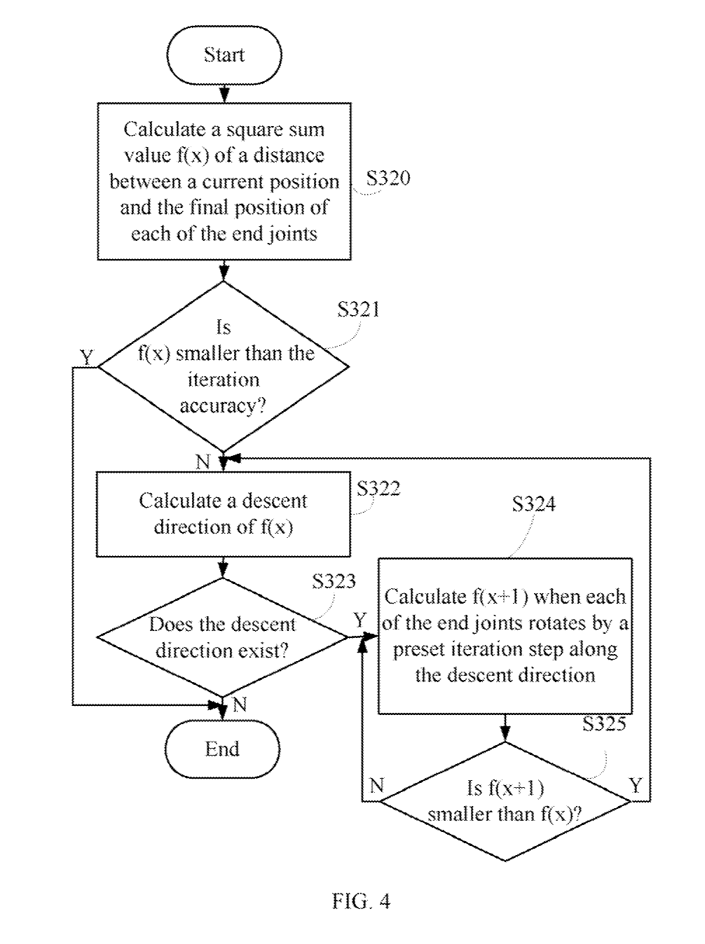

FIG. 4 is a detailed flowchart of one embodiment of block S31 and block S32 in FIG. 3. Depending on the embodiment, additional blocks may be added, others removed, and the ordering of the blocks may be changed.

In block S320, the computer 1 determines a square sum value

$$f ( x ) = Min {\sum }_{n = 1}^{n} ( {dn}^{2} )$$

of a distance between the current position and the final position of each of the end joints of the mechanical arm 2. The “n” of f(x) denotes an amount of the sections of the mechanical arm 2, as an example shown in FIG. 2, n=3. The “dn” denotes a distance of the end joint of the nth section of the mechanical arm 2. An initial distance of each of the end joints is between the origin position and the final position. For example, “d1” denotes a distance between the current position and the final position of the end joint B of the first section. An initial distance of “d1” is the distance between the origin position and the final position of the end joint B. Because that the origin coordinate of the end joint B of the first section is (X1_{B}, Y1_{B}, Z1_{B}), then

d1=\sqrt{(X_{B}′-X1_{B})²+(Y_{B}′-Y1_{B})²+(Z1_{B}^{′}-Z1_{B})²}.

The coordinate (X_{B}^{'}'Y_{B}^{'}'Z_{B}^{'}) may be the coordinate of the end joint B when the first section of the mechanical arm 2 rotates to a current position which is nearest to the final position. The unknown coordinate (X_{B}^{'}'Y_{B}^{'}'Z_{B}^{'}) can be represented by an expression of an angle α. The expression may be

$$( {X}_{B}^{′} , {Y}_{B}^{′} , {Z}_{B}^{′} , 1 ) = ( {X}_{A} , {Y}_{A} , {Z}_{A} , 1 ) * ( \begin{matrix}cos α & - sin α & 0 & 0 \\ sin α & cos α & 0 & 0 \\ 0 & 0 & 1 & 0 \\ 0 & 0 & 0 & 1\end{matrix} ) .$$

The angle α denotes the angle the first section of the mechanical arm 2 rotates. The end joint of each of the sections of the mechanical arm 2 can be represented by the expression of an angle each of the sections rotates. Thereby f(x) can be represented by the angle according to the expression. The minimum value of f(x) can be calculated by an iteration method by a preset iteration step. In one embodiment, the preset iteration step is the angle that each of the sections rotates. The minimum value of f(x) can be reached when the current position of each of the sections of the mechanical arm 2 is nearest to the final position of each of the sections.

In block S321, the computer 1 detects if f(x) is smaller than the iteration accuracy FunX. If f(x) is not smaller than the iteration accuracy FunX, block S322 is implemented. If f(x) is smaller than the iteration accuracy FunX, the procedure ends.

In block S322, the computer 1 calculates a descent direction of f(x). It may be understood that the descent direction of f(x) is a direction toward which the value of f(x) decreases.

In block S323, the computer 1 detects if the descent direction exists. If the descent direction exists, block S324 is implemented. If the descent direction does not exist, the procedure ends.

In block S324, f(x+1) is calculated when each of the end joints rotates by the preset iteration step along the descent direction. The method of calculating f(x+1) is the same as the method for calculating f(x) in block S320.

In block S325, the computer 1 detects if f(x+1) is smaller than f(x). If f(x+1) is smaller than f(x), block S322 is repeated. If f(x+1) is not smaller than f(x), block S324 is repeated.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-based method for rotating a mechanical arm, the method comprising:
(a) receiving origin position parameters and final position parameters of the mechanical arm, the origin position parameters comprising origin coordinates of each of base joints and each of end joints of each of sections of the mechanical arm when the mechanical arm is at an origin position, the final position parameters comprising final coordinates of each of the base joints and each of the end joints of each of the sections when the mechanical arm is at a final position;
(b) determining a position that each of the end joints of each of the sections arrives after each iteration according to the origin position parameters and the final position parameters;
(c) calculating a distance between the current position and the final position of each of the end joints of each of the sections, obtaining a minimum distance, and calculating coordinates of each of the end joints of each of the sections corresponding to the minimum distance; and
(d) driving each of the end joints to rotate to the calculated coordinates of each of the end joints of each of the sections corresponding to the minimum distance.

2. The method of claim 1, wherein block (a) comprises: receiving an iteration accuracy.

3. The method of claim 2, wherein block (c) comprises:
(c1) determining a square sum value f(x) of a distance between the current position and the final position of each of the end joints of each of the sections of the mechanical arm;
(c2) detecting if a descent direction of f(x) exists if f(x) is not smaller than the iteration accuracy;
(c3) ending the procedure if the descent direction does not exist;
(c4) calculating f(x+1) when each of the end joints rotates by a preset iteration step along the descent direction if the descent direction exists;
(c5) repeating block (c4) if f(x+1) is not smaller than f(x); and
(c6) repeating blocks (c2) to (c4) if f(x+1) is smaller than f(x).

4. The method of claim 3, wherein the preset iteration step is an angle of each of the sections of the mechanical arm rotates.

5. A medium having stored therein instructions that, when executed by a computer, causes the computer to perform a method for rotating a mechanical arm, the method comprising:
(a) receiving origin position parameters and final position parameters of the mechanical arm, the origin position parameters comprising origin coordinates of each of base joints and each of end joints of each of sections of the mechanical arm when the mechanical arm is at an origin position, the final position parameters comprising final coordinates of each of the base joints and each of the end joints of each of sections when the mechanical arm is at a final position;
(b) determining a position that each of the end joints of each of the sections arrives after each iteration according to the origin position parameters and the final position parameters;
(c) calculating a distance between the current position and the final position of each of the end joints of each of the sections, obtaining a minimum distance, and calculating coordinates of each of the end joints of each of the sections corresponding to the minimum distance; and
(d) driving each of the end joints to rotate to the calculated coordinates of each of the end joints of each of the sections corresponding to the minimum distance.

6. The medium of claim 5, wherein block (a) comprises: receiving an iteration accuracy.

7. The medium of claim 6, wherein block (c) comprises:
(c1) determining a square sum value f(x) of a distance between the current position and the final position of each of the end joints of each of the sections of the mechanical arm;
(c2) detecting if a descent direction of f(x) exists if f(x) is not smaller than the iteration accuracy;
(c3) ending the procedure if the descent direction does not exist;
(c4) calculating f(x+1) when each of the end joints rotates by a preset iteration step along the descent direction if the descent direction exists;
(c5) repeating block (c4) if f(x+1) is not smaller than f(x); and
(c6) repeating blocks (c2) to (c4) if f(x+1) is smaller than f(x).

8. The medium of claim 7, wherein the preset iteration step is an angle of each of the sections of the mechanical arm rotates.
